(19) United States
(12) Patent Application Publication
(10) Pub. No.: US 2004/0177718 A1
(43) Pub. Date: Sep. 16, 2004

(54) Harmonic drive

(76) Inventor: Frank Poehlau, Fuerth (DE)

Correspondence Address: BURNS DOANE SWECKER & MATHIS L L P, POST OFFICE BOX 1404, ALEXANDRIA, VA, 22313-1404, US

(21) Appl. No.: 10/475,303

(22) PCT Filed: Mar. 13, 2002
(86) PCT No.: PCT/EP02/02757

(30) Foreign Application Priority Data
Apr. 21, 2001 (DE) 101 20 735.2

(51) Int. Cl. F16H 33/00

(52) U.S. Cl. 74/640

(57) ABSTRACT

The invention relates to a harmonic drive which can be manufactured from a small number of plastic injection moulded parts, dispensing with the additional space required for a sensor disk which is flange-mounted on the main drive pinion in order to detect kinematic information for a control circuit, by integrating the corresponding sensor equipment directly into the drive. Preferably, the rotating drive ring is fitted with at least one magnetic dipole as a sensor transmitter whereby the movement thereof when it passes a fixed position on the housing is detected by a stationary detector which is preferably embodied in the form of a Hall generator and mounted on the support ring of the drive.

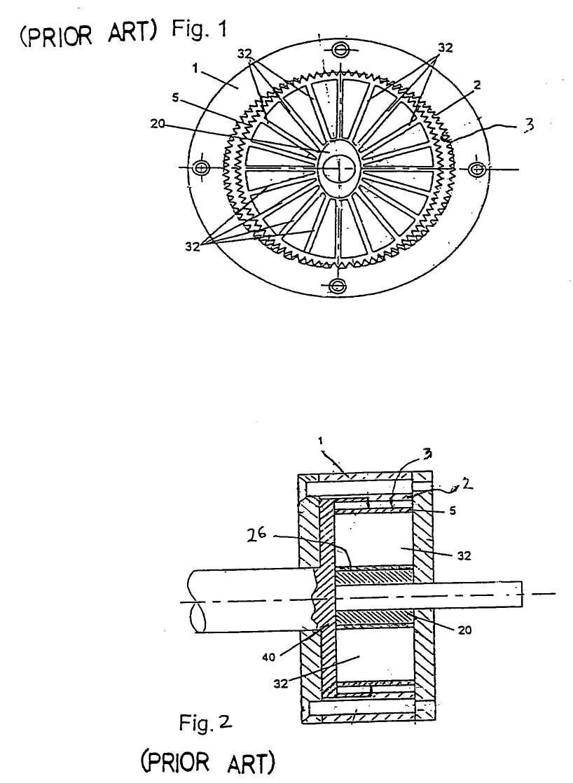

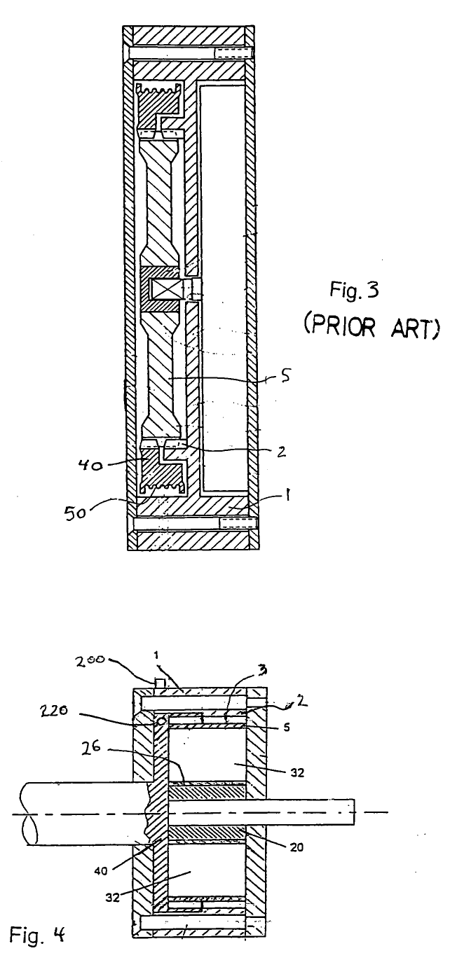

The invention relates to a harmonic drive according to the introductory clause of the major claim.

The function of such a harmonic drive, also known as a shaft drive or an annular band drive, being an irreversible greatly stepped-down, coaxial system, is based on the fact that a rotating, driven, non-cylindrical drive core, a so-called wave generator, radially deforms an inner hoop of the inner wheel while revolving, and pushes said inner hoop with its outer casing surface along a surrounding sector locally outward against the hollow cylindrical inner surface of a stationary rigid bearing ring fixed on the housing, whereby said inner surface has a slightly larger circumference. Thus, the inner wheel (or the wheel hoop mounted rotatably thereon) rolls traditionally over the gear-tooth system in the support ring with a positive fit. The wheel or its hoop rotates thereby slower than the motor-driven pinion of the wave generator depending on the amount of the circumferential difference between the support ring and the inner wheel. This greatly reduced rotation, compared to the drive, is preferably transferred via the outer gear-tooth system of the hoop of the inner wheel to the drive ring, which is axially and concentrically adjacent to the support ring whereby said drive ring is not stationary but is arranged coaxially rotatable in contrast to the support ring. In the embodiment disclosed in the otherwise type-forming German utility model 2 96 14 738 and described in more detail in the article “Genial einfach” (brilliantly simple), by H. Hirn (KEM Antriebstechnik, issue 10/1996) there is shown a harmonic drive, manufactured from a small number of plastic injection-molded parts, whereby the drive core is concentrically rotated as a wave generator (being approximately triangular or preferably oval in cross section) in the rotating radially deformable hub of the inner wheel. The spokes, being dimensionally stable in longitudinal direction between the hub and the wheel hoop, cause the engagement of the outer gear-tooth system with the coaxial inner gear-tooth system of the support ring, which is axially offset relative to the drive ring, whereby the engagement depends on the radial deformation of said outer gear-tooth system and whereby the engagement occurs only at the rotating offset sector of said support ring. As shown in a sketch in our German patent 19943021, the wheel rim of the drive ring disposed radially outside the inner gear-tooth system can serve directly as a belt pulley, which is equipped with a drive shaft mounted concentrically to the rotational axis of the wave generator—see also in this regard especially the development of this cup-shaped type of construction of the drive ring (output ring) described in more detail in our German patent application 10105814.4.

Driving of the wave generator is accomplished usually by means of a coaxially flange-mounted high-speed, low voltage DC motor, which is therefore cost-effective, and whose high rotation is reduced to a much slower rotation with a correspondingly greater torque for diverse use such as a control element for engine operation or air condition control and for other functions in a motor vehicle, especially functions replacing manual engagement. Should it be necessary in its use that revertive signaling is to be conducted through the actual angular position of said control element, for example, as actual value for a position control device, then a sensor disk is traditionally flange-mounted on the drive whereby said sensor disk is exemplary equipped with opto-electronically readable absolute or incremental angle encoding, which is, however, basically a disadvantage based on additionally-mounted operational parts, which are susceptible to failure, and the thereby necessary larger space requirements.

The present invention is based therefore on the technical object to further develop such a compact harmonic drive, which is nevertheless easy to be installed and which can be employed in diverse applications, and which has been already tested in practical use so that its functionality is significantly increased without the requirements for an enlarged space for installation thereof.

According to the characteristics combination of the major claim, the object is essentially achieved in that the movement of the drive ring past a stationary reference position is detected magnetically, for example, whereby the drive ring is preferably equipped locally with at least one sensor transmitter, such as a ferromagnetic or permanent-magnetic dipole, whose movement is detected by means of at least one stationary detector, such as a magnetic field sensor, which is integrated in the support ring.

In the scope of the present invention, the detectors can basically rotate together with the drive ring and the transmitters can be arranged stationary. However, should the latter be passive, which means they would act independently like a magnetic dipole, while the sensor detectors are to be equipped with supply lines and signal lines, which would have to be guided through slip rings to a stationary evaluation circuit and a control circuit—it would be more practical therefore to let the independent sensor transmitter rotate like magnetic dipoles. The sensor detectors, which are disposed on stationary parts near the rotating drive ring or the neighboring housing part (by being injection-molded or subsequently mounted thereon), are preferably designed as Hall generators in case of a magnetic transmitter. Said detectors react in a known manner to the changes of a magnetic field that is transverse to the electric current path with potential shifting which can be detected as a polarity-dependent signal voltage whereby current paths are shifted through a semiconductor element.

The sensor transmitter, such as magnetic dipoles, which are rotating together with the drive ring, can then be placed during the process of injection molding as ferromagnetic bars or as permanent bar magnets into the injection mold of the drive ring, depending on the material used therefor, and be embedded therein. Materials later to be locally magnetized are integrated into the drive ring in a multi-component injection molding process. Depending on the specific arrangement of the sensor transmitter disposed radial or axial adjacent to the drive ring, the axes of the adjusted and oriented sensor transmitter, such as magnetic dipoles, are oriented transversely or longitudinally relative to the rotation axis of the harmonic drive.

Based on the response to a sensor transmitter, such as a dipole, a detector signals the reaching of a constructively set angular position of the drive ring relative to the stationary housing, and the periodicity of this response corresponds to the rotational speed of the drive ring, for example, whenever a sensor transmitter is detected per rotation. Two sequential sensor transmitters, such as polarities in case of magnetic dipoles, which are significantly offset in rotation direction, make it possible to detect the direction of rotation, whereby the two responses of the sensor detector are picked up, which means here that the two polarities are sequentially detected of the one dipole aligned in the direction of rotation or of the two dipoles that are offset non-parallel and transversely thereto; or undistinguishable sensor transmitters rotate on juxtaposed tracks whereby one sensor transmitter is designated for each of said tracks in order to detect which one of the two dipoles follows the other one or moves to the front relative to the direction of rotation.

The issue discussed above, with its direct reference to permanent magnetic sensor equipment, can also be realized in the framework of the present invention with sensor equipment that is based on other physical occurrences. Thus, a light source can serve as sensor transmitter and a light-sensitive element can serve as a detector, possibly through the use of a selected modulated, polarized or spectral light so that general interfering ambient influences can be kept in control without problems; or the sensor equipment is realized as a capacitive system.

In a harmonic drive manufactured from a small number of plastic injection-molded parts, the additional space required for a sensor disk is no longer necessary, whereby said harmonic drive is flange-mounted on the main drive pinion to detect kinematic information for a control circuit while directly integrated into the drive in said drive according to the invention. According to a development of the invention, the rotating disk ring is preferably fitted with at least one independent sensor transmitter, such as a dipole, whose movement is detected by a stationary detector when it passes a fixed position in the housing whereby said stationary detector is preferably realized as a Hall generator and arranged on the support ring of the harmonic drive.

1. A harmonic drive with a wave generator drive core disposed in a rotating radial deformable inner wheel that is fitted in a stationary, dimensionally stable support ring and in an axially neighboring, rotatably mounted drive ring, which is also radially and dimensionally stable and which has a somewhat larger respective inner diameter than the non-deformed outer diameter of said inner wheel whereby the rotatable ring, on the one hand, and the stationary ring or the drive housing, on the other hand, are equipped with sensor transmitters or sensor detectors, characterized in that the sensor transmitters are injection-molded in the rotary drive ring.

2. A harmonic drive according to claim 1, wherein there are provided magnetic or inductive, capacitive or opto-electronic sensor transmitters.

3. A harmonic drive according to claim 1, wherein the drive ring is equipped with at least one independently operating sensor transmitter without external energy supply, and the support ring or the housing is equipped with at least one detector.

4. A harmonic drive according to the previous claim, wherein the drive ring is equipped with at least one magnetic dipole as sensor transmitter, and the support ring or the housing is equipped with at least one sensor detector designated for the rotation path of the dipole.

5. A harmonic drive according to the previous claim, wherein ferromagnetic or permanent-magnetic dipoles of a bar-shaped design are provided as sensor transmitters.

6. A harmonic drive according to the previous claim, wherein dipoles provided as sensor transmitters are oriented axis-parallel in the drive ring and whose sensor detectors designated for movement paths are arranged on the support ring.

7. A harmonic drive according to one of the claims 4 through 6, wherein alternating magnetic polarities, which are in sequence in the direction of movement, can be detected by said detector.

8. A harmonic drive according to one of the claims 4 through 7, wherein a plurality of dipoles rotate as sensor transmitters on juxtaposed tracks whereby one sensor detector is designated for each of said tracks.

9. A harmonic drive according to one of the claims 4 through 8, wherein dipoles are acting as sensor transmitters injection-molded by multi-component injection molding in the magnetizable areas of the drive ring.

10. A harmonic drive according to one of the claims 4 through 9, wherein sensor detectors are Hall generators to detect magnetic dipoles as the sensor transmitters.
